(19) United States
(12) Patent Application Publication
(10) Pub. No.: US 2021/0064198 A1
(43) Pub. Date: Mar. 4, 2021

(54) DISPLAY METHOD AND DISPLAY DEVICE

(71) Applicant: SEIKO EPSON CORPORATION, Tokyo (JP)

(72) Inventor: Yusuke YAMADA, Nagano (JP)

(21) Appl. No.: 17/005,926

(22) Filed: Aug. 28, 2020

(30) Foreign Application Priority Data
Aug. 30, 2019 (JP) 2019-157926

(51) Int. Cl. G06F 3/0483; G06F 3/0482; G09G 3/10

(52) U.S. Cl. CPC G06F 3/0483; G09G 2340/045; G09G 3/10; G06F 3/0482

(57) ABSTRACT

A display method according to the present disclosure includes a specifying step of, in an image group including a standard image having size of a standard size and a nonstandard image having size different from the standard size, reducing, for the nonstandard image, an enlargement/reduction magnification with respect to the standard size and specifying display sizes of the standard image and the nonstandard image and a display step of displaying, based on the specified display sizes, images including the standard image and the nonstandard image.

The present application is based on, and claims priority from JP Application Serial Number 2019-157926, filed Aug. 30, 2019, the disclosure of which is hereby incorporated by reference herein in its entirety.

### BACKGROUND

### 1. Technical Field

The present disclosure relates to a display method and a display device.

### 2. Related Art

In recent years, in various display devices, it has been adopted to display, side by side, as a list, a predetermined number of reduced images of a plurality of images and display a thumbnail in which description contents in read images can be confirmed.

In the thumbnail, information concerning a large number of images is displayed in one screen by displaying the images, that is, pages side by side. Description contents of the image displayed in the thumbnail are discriminated. A display device adapted to display images having different sizes side by side in the thumbnail has been proposed (see, for example, JP-A-2006-166146 (Patent Literature 1)).

In the display device having such a configuration, the images having the different sizes are displayed side by side in the thumbnail as explained above. Consequently, it is possible to feel the sizes of the images included in the thumbnail and discriminate the description contents of the images.

However, when the images having the different sizes are displayed in the thumbnail with similarity ratios of the images directly reflected on the images, it is difficult to visually recognize the description contents of, in particular, images having small sizes.

### SUMMARY

The present disclosure has been devised to solve the problems described above and can be realized as the following application examples.

A display method according to an application example of the present disclosure includes: a specifying step of, in an image group including a standard image having size of a standard size and a nonstandard image having size different from the standard size, reducing, for the nonstandard image, an enlargement/reduction magnification with respect to the standard size and specifying display sizes of the standard image and the nonstandard image; and a display step of displaying, based on the specified display sizes, images including the standard image and the nonstandard image.

### BRIEF DESCRIPTION OF THE DRAWINGS

FIG. 1 is a plan view showing an exterior of a viewer in an embodiment.

FIG. 2A is a partially enlarged plan view showing a thumbnail image bundle and an enlarged and displayed thumbnail image displayed in an image display section included in the viewer shown in FIG. 1.

FIG. 2B is a partially enlarged plan view of a B part in the thumbnail image bundle shown in FIG. 2A.

FIG. 3 is a block diagram showing a system configuration of the viewer.

FIG. 4 is a block diagram showing a system configuration of the viewer.

FIG. 5 is a flowchart showing an example of processing of the viewer.

FIG. 6 is a flowchart showing an example of processing of the viewer.

FIG. 7A is a flowchart showing an example of processing of the viewer.

FIG. 7B is a graph for explaining Expression (1), which is an example of an expression for determining an enlargement/reduction magnification.

FIG. 8A is a flowchart showing an example of processing of the viewer.

FIG. 8B is a diagram for explaining processing for determining a rotation angle.

FIG. 9A is a diagram for explaining generation processing for a thumbnail image.

FIG. 9B is a diagram for explaining the generation processing for a thumbnail image.

FIG. 9C is a diagram for explaining the generation processing for a thumbnail image.

FIG. 9D is a diagram for explaining the generation processing for a thumbnail image.

FIG. 9E is a diagram for explaining the generation processing for a thumbnail image.

FIG. 10A is a diagram for explaining a method of arranging a thumbnail image.

FIG. 10B is a diagram for explaining the method of arranging a thumbnail image.

FIG. 10C is a diagram for explaining the method of arranging a thumbnail image.

FIG. 11 is a flowchart showing an example of processing of the viewer.

FIG. 12 is a diagram for explaining a center spread.

FIG. 13 is a flowchart showing an example of processing of the viewer.

FIG. 14 is a diagram for explaining an arrangement method in which a center spread is arranged in a dynamic portion.

FIG. 15 is a flowchart showing an example of processing of the viewer.

FIG. 16 is a diagram of enlarged display of a thumbnail image bundle.

FIG. 17 is a diagram of display of a thumbnail image bundle in which the number of images in the dynamic portion is smaller than a predetermined number of images.

FIG. 18 is a diagram of display of a thumbnail image bundle in which the number of images in the dynamic portion is smaller than the predetermined number of images.

FIG. 19 is a diagram in which an operation thumbnail image and thumbnail images adjacent to the operation thumbnail image are displayed with intervals between the operation thumbnail image and the thumbnail images increased.

FIG. 20 is a diagram in which the operation thumbnail image and the thumbnail images adjacent to the operation thumbnail image are displayed not to overlap.

FIG. 21 is a diagram for explaining a method of shifting the thumbnail image in the dynamic portion to a static portion and displaying the thumbnail image.

FIG. 22 is a diagram in which a thumbnail image in the dynamic portion is shifted to the static portion and displayed.

FIG. 23 is a diagram for explaining a method of reducing the width of a thumbnail image bundle and displaying the thumbnail image bundle.

FIG. 24 is a diagram for explaining the method of reducing the width of a thumbnail image bundle and displaying the thumbnail image bundle.

FIG. 25 is a partially enlarged plan view of a thumbnail image bundle at the time when the thumbnail image in the thumbnail image bundle is displayed without reducing an enlargement/reduction magnification.

### DESCRIPTION OF EXEMPLARY EMBODIMENTS

A display method and a display device according to the present disclosure are explained in detail below based on preferred embodiment shown in the accompanying drawings.

In the embodiment explained below, before explaining the display method according to the present disclosure, as an application of the display device according to the present disclosure, a viewer capable of viewing and editing an electronic manual or an electronic book, which is an example of a document including images, and a document created by a user is explained as an example.

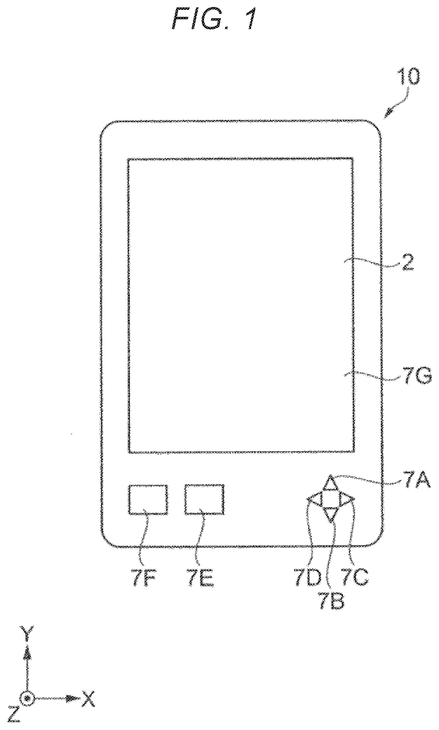

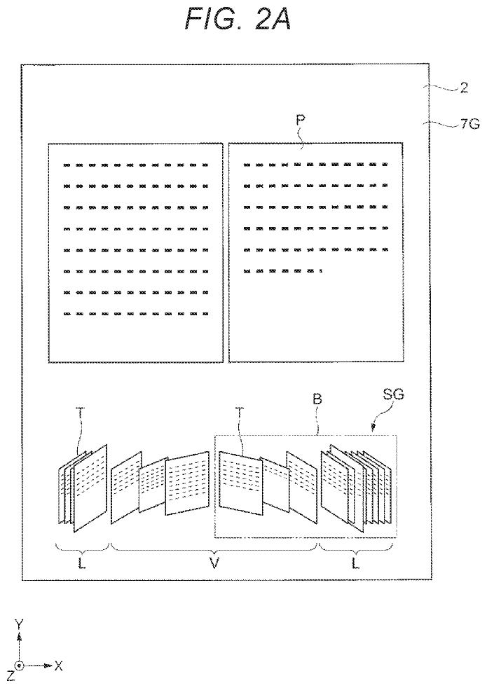

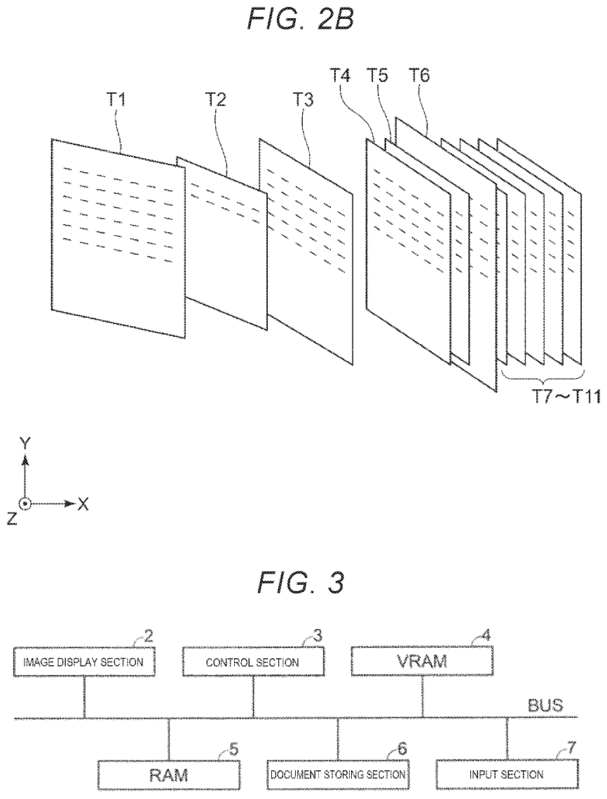

In the drawings referred to in the following explanation, for convenience of explanation and illustration, vertical and horizontal scales of members or portions are sometimes shown to be different from actual scales. Illustration of components other than components necessary for explanation is sometimes omitted. In the following explanation, for convenience of explanation, in each of FIG. 1, FIG. 2A, FIG. 2B, and FIGS. 16 to 25, an X axis, a Y axis, and a Z axis are respectively illustrated as three axes orthogonal to one another. A distal end side of arrows indicating the axes is represented as “+” and a proximal end side of the arrows is represented as “−”. A direction along the X axis is referred to as “horizontal direction”, which is a first direction, a direction along the Y axis is referred to as “vertical direction”, which is a second direction, and a direction along the Z axis is referred to as “depth direction”. In the following explanation, a −X direction of the horizontal direction is represented as left or a left side, a +X direction of the horizontal direction is represented as right or a right side, a −Y direction of the vertical direction is represented as lower or a lower side, and a +Y direction of the vertical direction is represented as upper or an upper side. In the following explanation, among images partially superimposed and arranged along the direction along the X axis, an image located on a near side (a +Z-axis side) is represented as an image located in “front” and an image located on a depth side (a −Z-axis side) is represented as an image located in “rear”. In this embodiment, the first direction is the horizontal direction and the second direction is the vertical direction. However, the first direction may be the vertical direction and the second direction may be the horizontal direction. That is, the first direction and the second direction only have to cross each other.

### Viewer

First, an overview of a viewer 10 is explained with reference to FIG. 1 and FIGS. 2A and 2B.

FIG. 1 is a plan view showing an exterior of a viewer in the embodiment. FIG. 2A is a partially enlarged plan view showing a thumbnail image bundle and an enlarged and displayed thumbnail image displayed in an image display section included in the viewer shown in FIG. 1. FIG. 2B is a partially enlarged plan view of a B part in the thumbnail image bundle shown in FIG. 2A.

In this embodiment, the viewer 10 is a display device that displays an image. The viewer 10 includes an image display section 2 that displays the image and buttons 7A to 7F and a touch panel 7G functioning as an input section 7.

In this example, the viewer 10 is a device for viewing an electronic book, which is an example of a document, a so-called electronic book reader. The electronic book is document data including images of a plurality of pages. The viewer 10 displays the electronic book on the image display section 2 in a certain unit. The certain unit is, for example, each one page. Among the plurality of pages included in the electronic book, a page to be displayed is referred to as selected page. The selected page is changed according to operation of the buttons 7A to 7F or the touch panel 7G shown in FIG. 1 by the user. That is, the user can turn the page of the electronic book by operating the buttons 7A to 7F or the touch panel 7G. The viewer 10 has a function of executing application programs in addition to the viewing of the electronic book.

The image display section 2 displays, as shown in FIG. 2A, thumbnail images T, which are images formed by reducing pages of an electronic manual or an electronic book or a document created by the user, and an original image P of a selected thumbnail image T. The image display section 2 displays a thumbnail image bundle SG, that is, an image group, which is an image bundle in which a plurality of thumbnail images T, that is, images are arranged side by side in the horizontal direction.

The thumbnail image bundle SG is arranged along the lower side of the image display section 2 in a lower part, which is a lower side in the vertical direction of the image display section 2. The lower end of the thumbnail image bundle SG sometimes extends to the outside of a display region of the image display section 2.

The thumbnail image T is an image having size occupying a part of the image display section 2 and is an image formed by reducing or enlarging the original image P. The original image P is an image of a page of an electronic manual or an electronic book or document data created by the user. The original image P may be an icon of an application program or an operation screen of the application program. An application program and the operation of the application program may be allocated to each of the plurality of thumbnail images T.

The viewer 10 includes, on a surface on which the image display section 2 is arranged, the buttons 7A to 7F and the touch panel 7G functioning as the input section 7. The input section 7 receives an input from the outside. The input section 7 receives operation by the user and processes the operation as an input signal. That is, the user operates the input section 7 and performs a predetermined input to the viewer 10.

### System Configuration of the Viewer

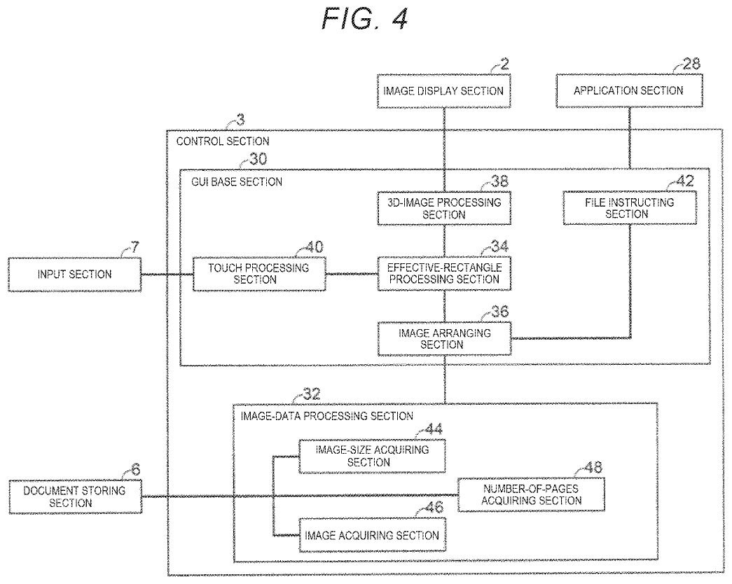

A system configuration of the viewer 10 is explained with reference to FIGS. 3 and 4.

FIGS. 3 and 4 are block diagrams showing the system configuration of the viewer 10.

The viewer 10 includes, as shown in FIG. 3, the image display section 2, a control section 3, a VRAM (Video Random Access Memory) 4, a RAM (Random Access Memory) 5, a document storing section 6, and an input section 7 coupled to a bus BUS. Exchange of signals or information among the sections coupled to the bus BUS is performed via the bus BUS.

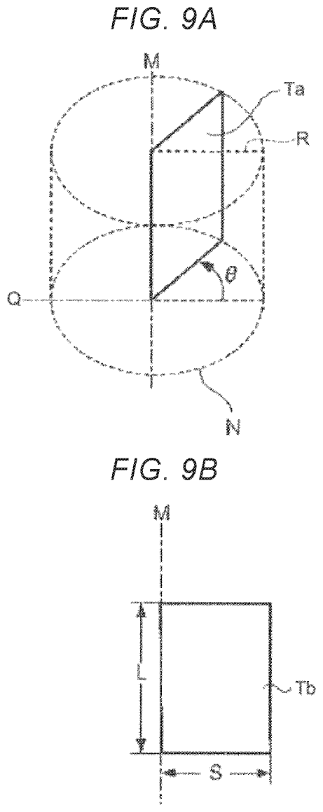

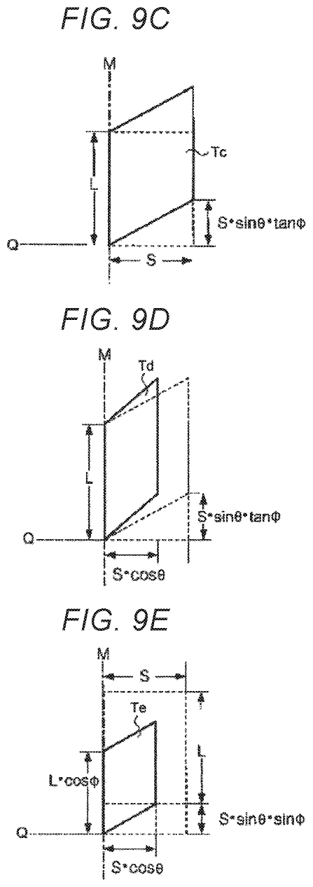

The image display section 2 displays the thumbnail image T corresponding to the original image P and the original image P of the thumbnail image T. In this embodiment, the image display section 2 displays the thumbnail image bundle SG in which the plurality of thumbnail images T are arranged side by side in the horizontal direction. The image display section 2 displays the plurality of thumbnail images T in a state in which the thumbnail image bundle SG is overlooked. As shown in FIG. 9E referred to below, the image display section 2 displays an overlooked image, which is an image formed by viewing, from any viewpoint in an imaginary space including a first imaginary rotation axis Q, which is a first imaginary axis, and a second imaginary rotation axis M, which is a second imaginary axis, the thumbnail image bundle SG arranged in the imaginary space.

The image display section 2 includes a not-shown display driving circuit that outputs a signal for causing a liquid crystal panel or the like to display an image. The image display section 2 displays, as an image including the thumbnail image T and the original image P, image data stored in the VRAM 4.

The control section 3 is a device that controls the sections of the viewer 10, for example, a microcomputer including a CPU (Central Processing Unit) and a ROM (Read Only Memory). The CPU executes programs stored in the ROM or the RAM 5 using the RAM 5 as a work area. The ROM stores, for example, an OS (Operating System) program for controlling a basic operation of the viewer 10.

The control section 3 controls the sections of the viewer 10 based on the programs stored in the ROM. For example, the control section 3 performs control for causing the VRAM 4 to store various image data and control for specifying, from an input signal sent from the input section 7, the buttons 7A to 7F and the touch panel 7G operated by the user and content of the operation and operating the viewer 10 based on the operated buttons 7A to 7F and the operated touch panel 7G and the content. Further, the control section 3 controls image processing for an image displayed on the image display section 2. As the image processing, for example, processing for enlarged display of a selected page and display highlighting for the thumbnail image T is performed.

The VRAM 4 is a memory that stores image data indicating an image displayed on the image display section 2. The VRAM 4 is a memory in which developed image data is stored. The image data stored in the VRAM 4 is displayed on the image display section 2.

The RAM 5 is a memory in which association between content of the image processing executed by the control section 3 and the image data is stored.

The document storing section 6 is a rewritable memory. The document storing section 6 stores document data such as an electronic manual or an electronic book or a document created by the user. The document storing section 6 can store a plurality of different document data and rewrite the document data as appropriate. The document storing section 6 is a nonvolatile memory that stores various data and application programs in addition to the document data. For example, the document storing section 6 may be a semiconductor memory incorporated in the viewer 10, may be a detachably attachable external memory such as an SD memory card, or may be a database capable of communicating via a network such as the Internet.

The input section 7 includes the buttons 7A to 7F shown in FIG. 1. When the buttons 7A to 7F are operated, the input section 7 transmits an input signal corresponding to the operated button to the control section 3. The input section 7 includes the touch panel 7G.

In the viewer 10 having such a configuration, the control section 3 includes, as shown in FIG. 4, a GUI base section 30 functioning as an image generating section and an image-data processing section 32.

The GUI base section 30 functions as the image generating section and rotates each of the plurality of thumbnail images T arranged on the first imaginary rotation axis Q around respective second imaginary rotation axes M crossing the first imaginary rotation axis Q and further rotates the thumbnail image T around the first imaginary rotation axis Q to create, that is, generate the thumbnail image T. The GUI base section 30 creates an overlooked image, which is an image formed by viewing, from any viewpoint in an imaginary space, the thumbnail image bundle SG arranged in the imaginary space.

The GUI base section 30 includes an effective-rectangle processing section 34, an image arranging section 36, a 3D-image processing section 38, a touch processing section 40, and a file instructing section 42.

The effective-rectangle processing section 34 sets a thumbnail image display region, which is an occupied region.

The image arranging section 36 determines a rotation angle θ, that is, an inclination angle of the thumbnail image T that rotates around the second imaginary rotation axis M.

In a state in which the thumbnail image bundle SG formed by the plurality of thumbnail images T is displayed to partially overlap the thumbnail image T adjacent to the thumbnail image bundle SG, the image arranging section 36 divides the thumbnail image bundle SG into a static portion L in which the thumbnail images T are arranged at an equal interval and a dynamic portion V in which an interval between the adjacent thumbnail images T is set wider than the interval between the thumbnail images T in the static portion L and calculates a common standard page pitch in the static portion L and the dynamic portion V.

The image arranging section 36 calculates width of pages of a center spread and width shared by pages in the dynamic portion V excluding the standard page pitch of the pages and width occupied by the width of the pages of the center spread from entire image width.

The image arranging section 36 calculates, in the thumbnail image bundle SG, display sizes of the thumbnail images T to be displayed. At this time, in the present disclosure, the plurality of thumbnail images T included in the thumbnail image bundle SG include a standard image having size of a standard size and a nonstandard image having size different from the standard size. A display size of the nonstandard image in the thumbnail image bundle SG is determined by reducing an enlargement/reduction magnification with respect to the standard size. Details of the display size determination are explained below.

Further, the image arranging section 36 creates the thumbnail image T based on the rotation angle θ of the thumbnail image T, the common standard page pitch in the static portion L and the dynamic portion V, the display size of the thumbnail image T, and the like and determines an arrangement position of the thumbnail image T in the image display section 2.

The 3D-image processing section 38 draws the thumbnail images T on the image display section 2 based on arrangement positions of the plurality of thumbnail images T forming the thumbnail image bundle SG determined by the image arranging section 36. That is, the 3D-image processing section 38 displays the thumbnail image bundle SG.

At this time, in the present disclosure, as explained above, the thumbnail image T corresponding to the original image P includes, according to the size of the thumbnail image T, the standard image having the size of the display size and the nonstandard image having the size different from the standard size. The 3D-image processing section 38 displays, on the image display section 2, the thumbnail image bundle SG on which a difference between the sizes of the standard image and the nonstandard image is reflected, that is, in which the enlargement/reduction magnification with respect to the standard size is reduced concerning the nonstandard image. In other words, the 3D-image processing section 38 displays, based on the specified display sizes of the standard image and the nonstandard image, the thumbnail image bundle SG, that is, images including the standard image and the nonstandard image.

The 3D-image processing section 38 is configured by, for example, a Frame Buffer and a GPU.

The touch processing section 40 detects a touch on the touch panel 7G by the user. The touch processing section 40 acquires a touch signal from the touch panel 7G.

The file instructing section 42 instructs, based on data supplied from the touch processing section 40, the image-data processing section 32 to read, for example, the original image P of a page of document data. The file instructing section 42 is, for example, a function of Android (registered trademark) of an operation system for a mobile device.

The image-data processing section 32 is, for example, a PDF library.

The image-data processing section 32 includes an image-size acquiring section 44, an image acquiring section 46, and a number-of-pages acquiring section 48.

The image-size acquiring section 44 acquires size, that is, a size of the original image P forming pages of the document data from the document storing section 6. In other words, the image-size acquiring section 44 acquires, from the document storing section 6, the size of a diagonal line of the original image P, the size in the horizontal direction of the original image P, the size in the vertical direction of the original image P, and the like. At this time, in the present disclosure, as explained above, the thumbnail image T corresponding to the original image P includes, according to the size of the thumbnail image T, the standard image having the size of the display size and the nonstandard image having the size different from the standard size. The image-size acquiring section 44 distinguishes the standard image and the nonstandard image and respectively acquires the size of the standard image and the size of the nonstandard image.

The image acquiring section 46 acquires, from the document storing section 6, besides the original image P of the page of the document data and attributes of the original image P, for example, information concerning the original image P.

The information concerning the original image P includes information concerning images forming the plurality of thumbnail images T forming the thumbnail image bundle SG and further includes, when the plurality of thumbnail images T are formed as the thumbnail image bundle SG, that is, an image group, information concerning arrangement order and the like of the thumbnail images T.

The number-of-pages acquiring section 48 acquires the number of pages of the document data from the document storing section 6.

An application section 28 is application software such as printing software for a photograph, a document, and the like, New Year's card printing software, or projection software for projecting a photograph, a document, and the like with a projector.

### Operation of the Viewer

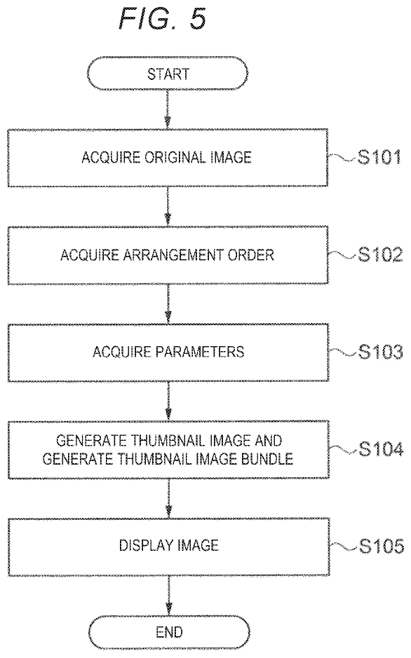

The operation of the viewer explained above is explained with reference to FIGS. 5 to 15.

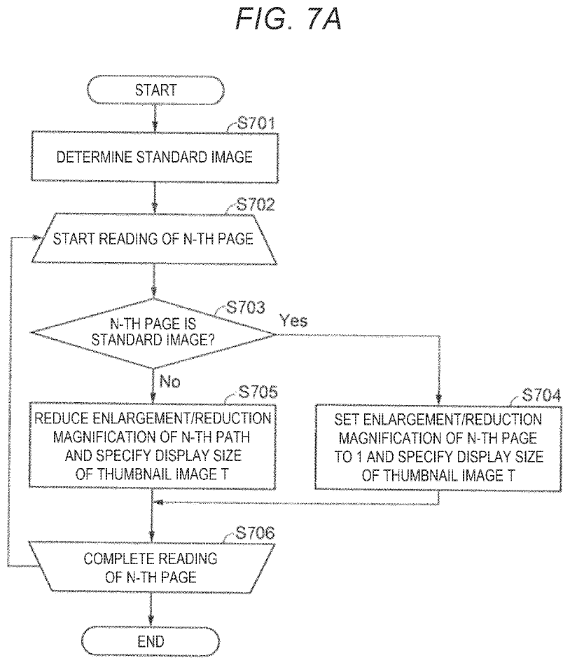

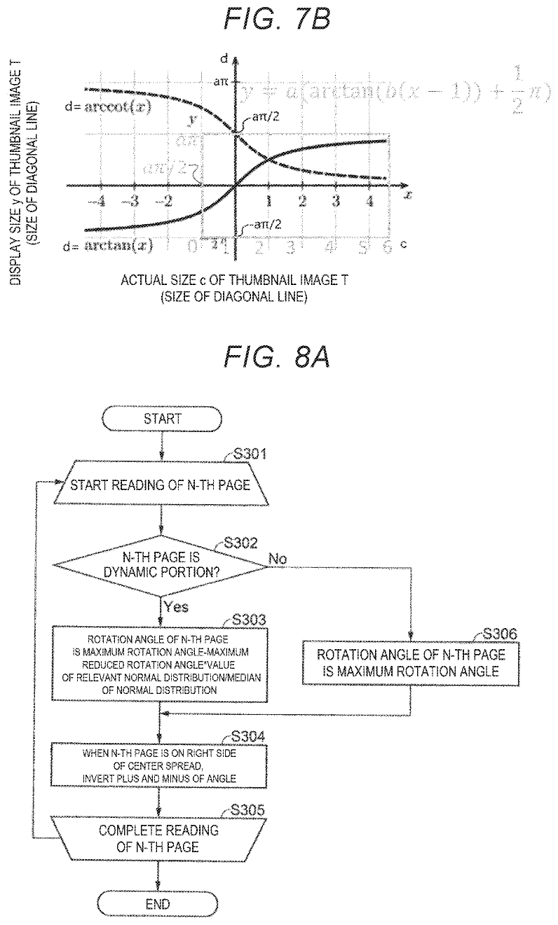

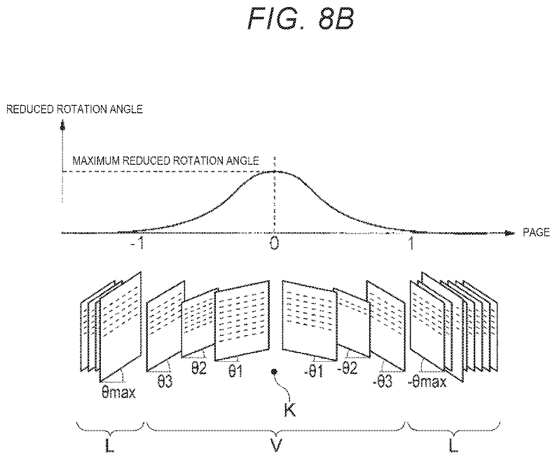

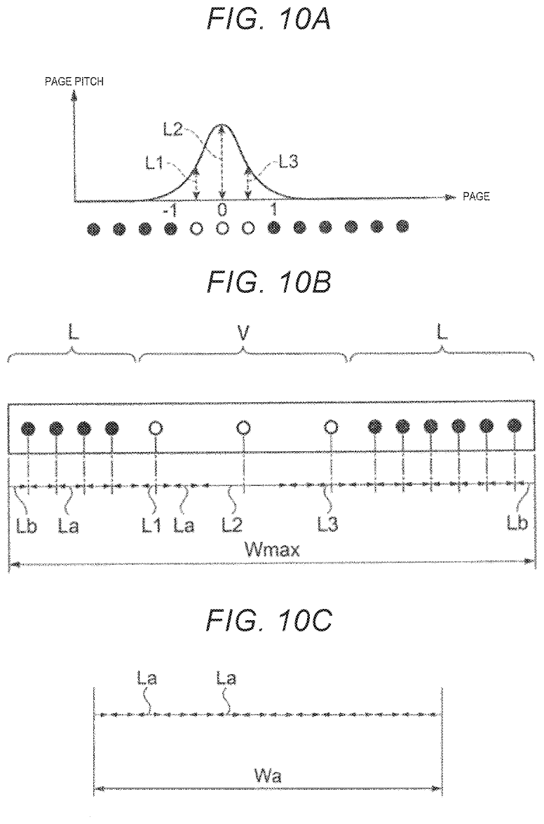

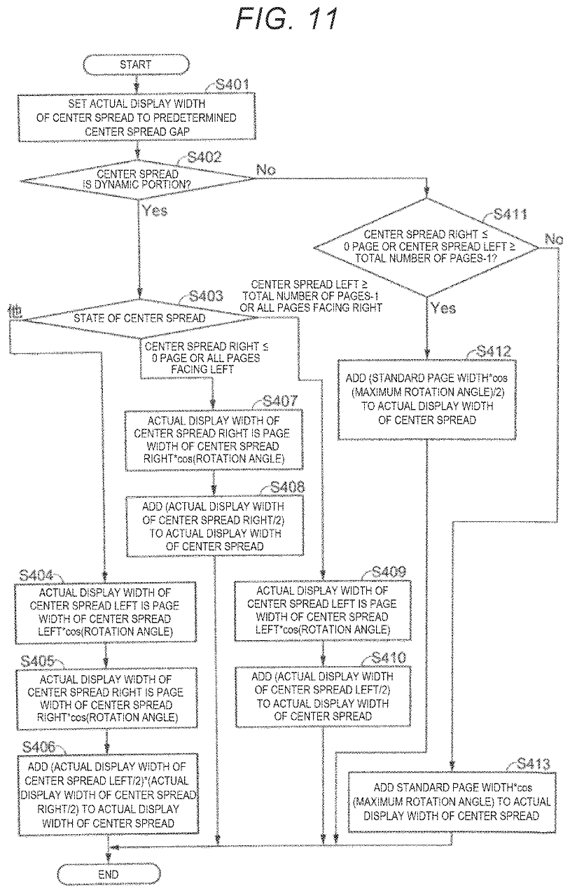

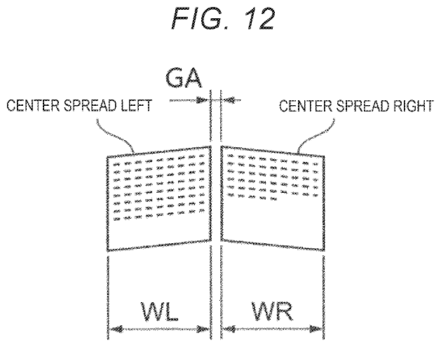

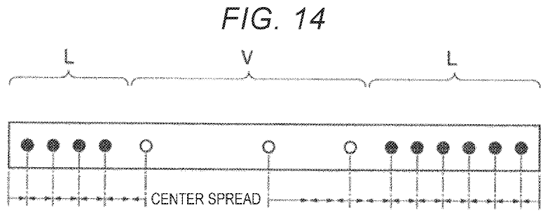

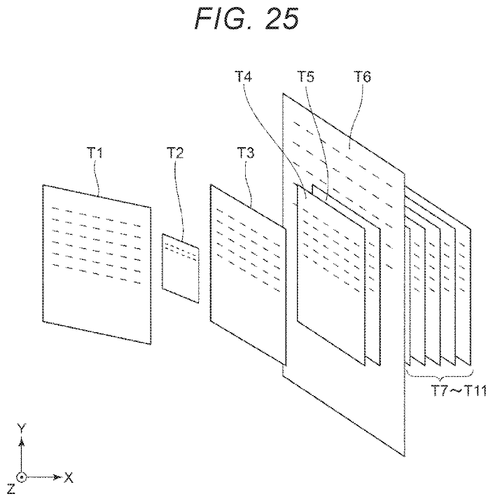

FIGS. 5, 6, 7A, 8A, 11, 13, and 15 are flowcharts showing examples of processing of the viewer 10. FIG. 7B is a graph for explaining Expression (1), which is an example of an expression for determining an enlargement/reduction magnification. FIG. 8B is a diagram for explaining processing for determining the rotation angle θ. FIGS. 9A to 9E are diagrams for explaining generation processing for a thumbnail image. FIGS. 10A to 10C are diagrams for explaining a method of arranging a thumbnail image. FIG. 12 is a diagram for explaining a center spread. FIG. 14 is a diagram for explaining an arrangement method in which a center spread is arranged in the dynamic portion. FIG. 25 is a partially enlarged plan view of a thumbnail image bundle at the time when the thumbnail image T in the thumbnail image bundle is displayed without reducing an enlargement/reduction magnification.

First, the operation of the control section 3 is explained below with reference to FIGS. 2A, 2B, and the like according to the flowchart of FIG. 5.

The control section 3 creates the thumbnail image bundle SG in which generated thumbnail images T are arranged in predetermined order (see FIG. 2B).

When forming the thumbnail image bundle SG, the image arranging section 36 specifies, in the thumbnail image bundle SG, display sizes of the thumbnail images T to be displayed. That is, the image arranging section 36 determines, using the display method according to the present disclosure, the display sizes of the thumbnail images T in the thumbnail image bundle SG.

The image arranging section 36 divides the thumbnail image bundle SG into the static portion L and the dynamic portion V, respectively calculates, based on the specified display sizes of the thumbnail images T, arrangement positions of the thumbnail images T in the static portion L and arrangement positions of the thumbnail images T in the dynamic portion V, and determines arrangement positions of the plurality of thumbnail images T forming the thumbnail image bundle SG.

The operations of the sections included in the control section 3 when displaying the thumbnail image bundle SG on the image display section 2 are explained in detail below.

A flow of FIG. 5 is started with a predetermined event as an opportunity, for example, when a power supply of the viewer 10 is turned on or, for example, display of a menu screen is instructed in the viewer 10.

First, in step S101, the file instructing section 42 instructs the image acquiring section 46 to read out, from the document storing section 6, the original image P designated by the user using the buttons 7A to 7F or the touch panel 7G of the input section 7. The control section 3, that is, the image acquiring section 46 acquires the thumbnail image bundle SG set as a processing target, in this example, original images P corresponding to the plurality of thumbnail images T included in the thumbnail image bundle SG.

Subsequently, in step S102, the control section 3, that is, the image acquiring section 46 acquires data indicating arrangement order of the plurality of thumbnail images T.

The data includes numbers indicating the arrangement order of the thumbnail images T and file names serving as identifiers of the thumbnail images T. The data is stored in the document storing section 6. In step S101, the control section 3 reads out the data from the document storing section 6 and acquires, from the document storing section 6, the original images P having the file names included in the data. In step S102, the control section 3 acquires, from the data, arrangement order in the thumbnail image bundle SG of the thumbnail images T, that is, a standard image and a nonstandard image.

Subsequently, in step S103, the control section 3, that is, the image-size acquiring section 44 acquires parameters used for display of the thumbnail image bundle SG. The parameters are stored in the document storing section 6 together with an identifier of the thumbnail image bundle SG.

The parameters to be acquired include the number of images of the original images P corresponding to the plurality of thumbnail images T and dimensions of the original images P. The number of images is a parameter indicating the number of the thumbnail images T included in the thumbnail image bundle SG.

In the present disclosure, the original images P corresponding to the plurality of thumbnail images T acquired by the image-size acquiring section 44 include a standard image having size of a standard size and a nonstandard image having size different from the standard size.

Among images sampled from a plurality of original images P, an image having size of the same size as size of a largest number of images is set as a standard image and an image having size of a size different from the same size are set as a nonstandard image. The plurality of original images P to be sampled may be all of the plurality of original images P or may be a part of the plurality of original images P but are preferably a part of the plurality of original images P. Consequently, it is possible to improve processing speed in determining the standard image.

Dimensions of an image are parameters indicating the size of a diagonal line of the original image P corresponding to the thumbnail image T forming the thumbnail image bundle SG, the size in the horizontal direction of the original image P, the size in the vertical direction of the original image P, and the like. However, when the thumbnail image T is generated by reducing or enlarging the original image P, the image-size acquiring section 44 preferably acquires the size of the diagonal line of the original image P as a dimension of the image of the original image P. Consequently, when the thumbnail images T are displayed in the thumbnail image bundle SG using the display method according to the present disclosure, even if the thumbnail image T having a different aspect ratio is included in the thumbnail images T, that is, the original images P, in the thumbnail image bundle SG, the thumbnail image T can be displayed with an enlargement/reduction magnification reduced considering that relative size of the entire original image P is reflected on the size of the thumbnail image T.

Subsequently, in step S104, the control section 3 creates the thumbnail image bundle SG using the thumbnail image T generated by the GUI base section 30. Specifically, the control section 3 reduces or enlarges, based on the size of the diagonal line of the original image P acquired by the image-data processing section 32 in step S103, the original image P acquired by the image-data processing section 32 in step S101 to generate the thumbnail image T and, thereafter, creates the thumbnail image bundle SG using the generated thumbnail image T.

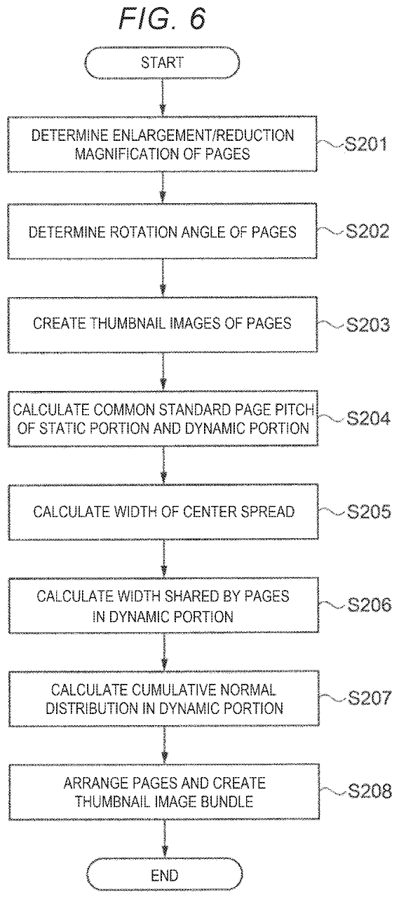

During the creation of the thumbnail image bundle SG, that is, the image group, the display method according to the present disclosure is applied when the original image P is reduced or enlarged. In the following explanation, operation for creating the thumbnail image T using the control section 3, determining a position where the thumbnail image T is arranged, and creating the thumbnail image bundle SG is explained according to the flowchart of FIG. 6.

First, in step S201, the image arranging section 36 determines, based on pages, that is, the original images P, an enlargement/reduction magnification of the thumbnail images T displayed in the thumbnail image bundle SG. This operation is explained below according to the flowchart of FIG. 7A.

First, in step S701, the image arranging section 36 samples the sizes of diagonal lines of all or apart of the plurality of original images P and determines, as a standard image, an image having size of the diagonal line of the same size as size of diagonal lines of a largest number of images among the sampled sizes of the diagonal lines and determines, as a nonstandard image, an image having another size of the diagonal line.

Subsequently, in step S702, the image arranging section 36 starts reading of the size of a diagonal line of an N-th page of the original image P. N is an integer equal to or larger than 1.

Subsequently, in step S703, when the size of the diagonal line of the N-th page of the original image P coincides with the size of the diagonal line of the standard image, the image arranging section 36 specifies the N-th page of the original image P as the standard image, determines “Yes”, and proceeds to step S704. The image arranging section 36 sets an enlargement/reduction magnification of the thumbnail image T created to correspond to the original image P to 1, specifies a display size of the thumbnail image T of the N-th page, and proceeds to step S706.

When the size of the diagonal line of the N-th page of the original image P does not coincide with the size of the diagonal line of the standard image, the image arranging section 36 specifies the N-th page of the original image P as the nonstandard image, determines “No”, and proceeds to step S705. The image arranging section 36 reduces an enlargement/reduction magnification of the thumbnail image T created to correspond to the original image P with respect to the size of the thumbnail image T created to correspond to the original image P of the standard image, specifies a display size of the thumbnail image T of the N-th pages, and proceeds to step S706.

In the present disclosure, as explained above, the plurality of original images P include the standard image and the nonstandard image. When the thumbnail image bundle SG is generated with a similarity ratio of the standard image and the nonstandard image directly reflected on the thumbnail image bundle SG and the image display section 2 is caused to display the thumbnail image bundle SG as shown in FIG. 25, in the thumbnail image bundle SG, a size relation between the standard image and the nonstandard image is conspicuous. In particular, in the nonstandard image having a small display size, it is difficult to visually recognize description content of the nonstandard image. When the small nonstandard image is arranged in the static portion L, it is difficult to visually recognize even the presence of the nonstandard image. In FIG. 25, a thumbnail image T2 is a nonstandard image having size smaller than the standard image. A thumbnail image T6 is a nonstandard image having size larger than the standard image.

On the other hand, in the present disclosure, the similarity ratio of the standard image and the nonstandard image is not directly reflected. As shown in FIGS. 2A and 2B, when the thumbnail image SG is generated, a display size of the nonstandard image is specified with an enlargement/reduction magnification of the nonstandard image reduced with respect to the display size of the standard image.

Specifically, in the thumbnail image bundle SG shown in FIGS. 2A and 2B, for the thumbnail image T2, which is the nonstandard image having the size smaller than the standard image, a reduction magnification of the thumbnail image T2 with respect to the display size of the standard image is reduced and a display size of the thumbnail image T2 is specified. For the thumbnail image T6, which is the nonstandard image having the size larger than the standard image, an enlargement magnification with respect to the display size of the standard image is reduced and the display size of the thumbnail image T6 is specified.

Therefore, in the generated thumbnail image bundle SG, it is possible to suppress or prevent a situation in which the size relation between the standard image and the nonstandard image is conspicuous, it is difficult to visually recognize the description content of the nonstandard image having the small display size, or, further, when the small nonstandard image is arranged in the static portion L, it is difficult to visually recognize even the presence of the nonstandard image.

The display size of the nonstandard image only has to be reduced than an enlargement/reduction magnification with respect to the standard size, which is the size of the standard image. However, when the size of the diagonal line of the standard image is set to 1, the enlargement/reduction magnification of the standard image is set to 1, the size of the diagonal line of the nonstandard image is represented as c=(x+1) (c satisfies 0<c≤6), a limit value of an enlargement magnification is represented as aπ, and an inclination angle of the enlargement-reduction magnification is represented as b, the display size of the nonstandard image is preferably size determined by calculating the enlargement/reduction magnification y of the nonstandard image using the following Expression (1).

y=a(arctan(b(x−1))+π/2) (1)

The display size of the nonstandard image calculated using Expression (1) described above is size shown in FIG. 7B and has a limit value of an enlargement magnification and a limit value of a reduction magnification. The inclination angle b of the enlargement/reduction magnification of the nonstandard image is gentler farther away from an inflection point where c=1, that is, x=0. When c=1, that is, x=0, the enlargement/reduction magnification is minimized. When c=6, that is, x=5, the enlargement/reduction magnification is maximized and, specifically, gradually approaches the limit value aπ of the enlargement magnification. Accordingly, it is possible to more markedly exert the effects obtained by reducing the enlargement/reduction magnification.

Subsequently, in step S706, the image arranging section 36 returns to step S702 and repeats the operation in steps S702 to S705 by the number of pages. At a point in time when the N-th page is the last page, the image arranging section 36 completes reading of the size of a diagonal line of the original image P of the next page and ends the setting of the display size of the thumbnail image T corresponding to the original images P of the pages.

According to steps S701 to S706 explained above, a specifying step of, in an image group including a standard image having size of a standard size and a nonstandard image having size different from the standard size, reducing, concerning the nonstandard image, an enlargement/reduction magnification with respect to the standard size and specifying display sizes of the standard image and the nonstandard image.

Referring back to FIG. 6, in step S202, the image arranging section 36 determines the rotation angle θ of rotation around the second imaginary rotation axis M of pages shown in FIG. 9A explained below. This operation is explained according to the flowchart of FIG. 8A.

First, in step S301, the image arranging section 36 starts reading of an N-th page of the original image P. N is an integer equal to or larger than N.

Subsequently, in step S302, when the N-th page is not the dynamic portion V, the image arranging section 36 determines “No” and proceeds to step S306, sets the rotation angle θ of the N-th page as a maximum rotation angle θ max, and proceeds to step S304. When the N-th page is the dynamic portion V, the image arranging section 36 determines “Yes” and proceeds to step S303 and sets the rotation angle θ of the N-th page as “a maximum rotation angle-a maximum reduced rotation angle*a value of a relevant normal distribution/a median of the normal distribution”. The rotation angle θ of a page arranged in the dynamic portion V is calculated according to a normal distribution of a reduced rotation angle as shown in FIG. 8B. The rotation angle θ of the page is smaller as the page is closer to a predetermined position K in the center in the horizontal direction in the dynamic portion V. That is, a rotation angle θ1 of a page closest to the predetermined position K<a rotation angle θ2 of a page second closest to the predetermined position K<a rotation angle θ3 of a page third closest to the predetermined position K.

Subsequently, in step S304, the image arranging section 36 inverts plus and minus of an angle when a page is further on the right side than a center spread. That is, in a page on the right side of the predetermined position K, the image arranging section 36 sets the rotation angle θ to −θ1, −θ2, −θ3, and −θ max.

Subsequently, in step S305, the image arranging section 36 returns to step S301 and repeats the operation in steps S301 to S305 by the number of pages. At a point in time when the N-th page is the last page, the image arranging section 36 completes the reading of the original image P of the next page and ends the setting of the rotation angle θ of the pages.

Referring back to FIG. 6, in step S203, the control section 3 creates the thumbnail images T of the pages. Specifically, the control section 3 rotates, around the respective second imaginary rotation axes M crossing the first imaginary rotation axis Q, each of the plurality of thumbnail images T arranged on the first imaginary rotation axis Q in a display size on which the enlargement/reduction magnification specified to correspond to the images is reflected and further rotates the thumbnail image T around the first imaginary rotation axis Q to generate the thumbnail image T.

That is, as shown in FIG. 9A, the GUI base section 30 stands and arranges a page Ta on the first imaginary rotation axis Q set on an imaginary horizontal plane N in an imaginary space and rotates the page Ta from a reference position P, where a horizontal direction of the page Ta is parallel to a horizontal direction of the display region, around the respective second imaginary rotation axes M crossing the first imaginary rotation axis Q. Further, the GUI base section 30 creates an image formed by rotating, around the first imaginary rotation axis Q, at a not-shown depression angle ϕ, the page Ta rotated around the respective second imaginary rotation axes M in the imaginary space. That is, the GUI base section 30 creates an image formed by looking down the page Ta at the not-shown depression angle ϕ from a viewpoint above the upper side of the page Ta rotated around the second imaginary rotation axis M in the imaginary space. In other words, thumbnail images are generated as images formed by obliquely viewing the page Ta at the not-shown depression angle ϕ and overlooking the page Ta from a viewpoint above the upper side of the page Ta in the imaginary space. When a page is not rotated, the horizontal direction of the page is parallel to the horizontal direction of the display region and the rotation angle θ is 0°. The depression angle ϕ is a predetermined angle. The second imaginary rotation axis M is not limited to be parallel to the side in the second direction, which is the vertical direction, of the page and may cross the side in the horizontal direction of the page.

Specifically, first, the GUI base section 30 deforms, in the vertical direction, an image Tb having a long side L and a short side S shown in FIG. 9B, in which pages are viewed from the front, while not changing the lateral width of the image Tb and creates an image Tc formed by shifting the right side of the image Tb shown in FIG. 9B by S·sin θ·tan ϕ with respect to the left side. Subsequently, as shown in FIG. 9D, the GUI base section 30 creates an image Td formed by reducing the image Tc shown in FIG. 9C in the horizontal direction at a magnification of cos θ. As a result, the lateral width of the image Td changes to S·cos θ. Finally, as shown in FIG. 9E, the GUI base section 30 creates an image Te obtained by reducing the image Td shown in FIG. 9D in the vertical direction at a magnification of cos ϕ. As a result, the dimension in the vertical direction of the image Te changes to L·cos ϕ. Consequently, the thumbnail image T formed by rotating the page at the rotation angle θ around the second imaginary rotation axis M and further rotating the page around the first imaginary rotation axis Q is generated. In other words, the thumbnail image T at the time when the page is rotated at the rotation angle θ around the second imaginary rotation axis M and the page is looked down at the depression angle ϕ from the viewpoint above the upper side of the page is generated. That is, an inclined thumbnail image T is generated.

Referring back to FIG. 6 again, in step S204, the image arranging section 36 calculates a common standard page pitch La in the dynamic portion V and the static portion L.

The standard page pitch La is calculated by “an overall occupied width*a standard page pitch occupied width ratio/(the number of pages−1)”. When a page pitch is a normal distribution shown in FIG. 10A, as shown in FIG. 10B, the page pitch in the static portion L is the standard page pitch La and the page pitch in the dynamic portion V is a pitch including page pitches L1, L2, and L3 among standard page pitches La. The overall occupied width is length Wmax obtained by adding up a total of page pitches in the static portion L and a total of page pitches in the dynamic portion V and further adding two page pitches Lb at both ends equivalent to a half of “a standard page width*cos(maximum rotation angle θ max)”. The standard page pitch occupied width ratio is, as shown in FIG. 10C, a ratio of length Wa of a standard page pitch occupied width excluding the page pitches L1, L2, and L3 in the dynamic portion V to the length Wmax of the entire occupied width.

Subsequently, in step S205, the image arranging section 36 calculates width of a center spread. The center spread means two thumbnail image T across the predetermined position K in the dynamic portion V shown in FIG. 8B.

Operation for calculating width of a center spread by the image arranging section 36 is explained below according to the flowchart of FIG. 11.

First, in step S401, the image arranging section 36 sets an actual display width of the center spread to a predetermined center spread gap GA. The center spread gap GA is, as shown in FIG. 12, an interval between a page of center spread left and a page of center spread right.

Subsequently, when the center spread is the dynamic portion V in step S402, the image arranging section 36 determines “Yes” and proceeds to step S403. When a center spread state is “other”, which is not “center spread left≥total number of pages−1 or all pages facing right” and “center spread right≤0 page or all pages facing left”, in step S403, the image arranging section 36 proceeds to step S404 and sets an actual display width WL of the center spread left to “page width of the center spread left*cos(rotation angle θ)”. “All pages facing right” indicates that all pages are “center spread left” in FIG. 12. “All pages facing left” indicates that all pages are “center spread right” in FIG. 12.

Subsequently, in step S405, the image arranging section 36 sets an actual display width WR of the center spread right to “page width of the center spread right*cos(rotation angle θ)”.

Subsequently, in step S406, the image arranging section adds “(actual display width WL of the center spread left/2)+(actual display width WR of the center spread right/2) to the actual display width of the center spread and ends the calculation of the actual display width of the center spread.

Subsequently, returning to step S403, when the center spread state is “center spread right≤0 page or all pages facing left”, the image arranging section 36 proceeds to step S407 and sets the actual display width WR of the center spread right to “page width of the center spread right*cos(rotation angle θ)”.

Subsequently, in step S408, the image arranging section 36 adds “actual display width WR of the center spread right/2” to the actual display width of the center spread and ends the calculation of the actual display width of the center spread.

Returning to step S403 again, when the center spread state is “center spread left≥a total number of pages−1 or all pages facing right”, the image arranging section 36 proceeds to step S409 and sets the actual display width WL of the center spread left to “page width of the center spread left*cos(rotation angle θ)”.

Subsequently, in step S410, the image arranging section 36 adds “actual display width WL of the center spread left/2” to the actual display width of the center spread and ends the calculation of the actual display width of the center spread.

Subsequently, returning to step S402, when the center spread is not the dynamic portion V, the image arranging section 36 determines “No” and proceeds to step S411. In step S411, when “center spread right≤0 page or center spread left≥total number of pages−1” is satisfied, the image arranging section 36 determines “Yes” and proceeds to step S412.

In step S412, the image arranging section 36 adds “standard page width*cos(maximum rotation angle θ max)/2” to the actual display width of the center spread and ends the calculation of the actual display width of the center spread.

Subsequently, returning to step S411, when “center spread right≤0 page or center spread left≥a total number of pages−1” is not satisfied, the image arranging section 36 determines “No” and proceeds to step S413. In step S413, the image arranging section 36 adds “standard page width*cos(maximum rotation angle θ max)” to the actual display width of the center spread and ends the calculation of the actual display width of the center spread.

Referring back to FIG. 6 again, in step S206, the image arranging section 36 calculates width shared by pages in the dynamic portion V.

The width shared by the pages in the dynamic portion V is calculated by “entire occupied width*(1−standard page pitch occupied width ratio)−actual display width of the center spread”. The entire occupied width is the length Wmax obtained by adding up a total of page pitches in the static portion L and a total of page pitches in the dynamic portion V and further adding one page pitch in the static portion L. The standard page pitch occupied width ratio is a ratio of the length Wa of the standard page pitch occupied width to the length Wmax of the entire occupied width.

Subsequently, in step S207, the image arranging section 36 calculates a cumulative normal distribution in the dynamic portion V.

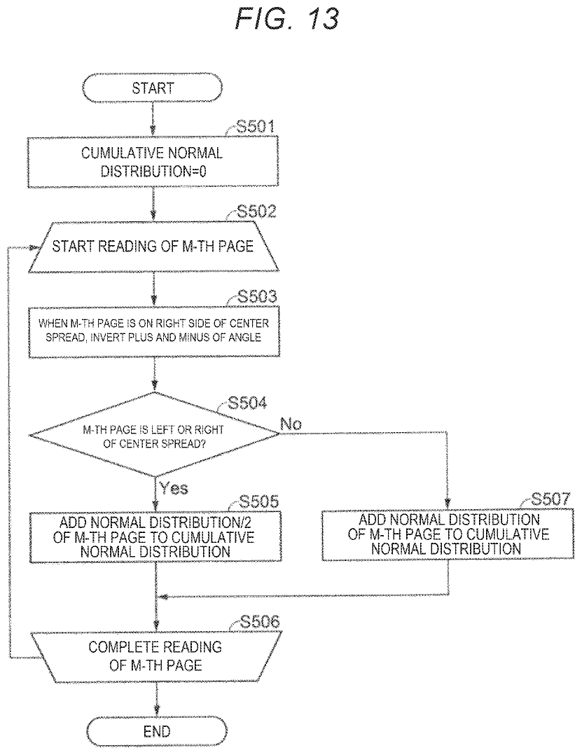

Operation for calculating a cumulative normal distribution in a dynamic portion by the image arranging section 36 is explained according to the flowchart of FIG. 13.

First, in step S501, the image arranging section 36 sets the cumulative normal distribution to “0”.

Subsequently, in step S502, the image arranging section 36 starts reading of an M-th page in the dynamic portion V. M is an integer equal to or larger than 1.

Subsequently, in step S503, when the M-th page is on the right side of the center spread, the image arranging section 36 inverts plus and minus of an angle of the rotation angle θ.

Subsequently, when the M-th page is the left or the right of the center spread in step S504, the image arranging section 36 determines “Yes” and proceeds to step S505. In step S505, the image arranging section 36 adds “normal distribution of the M-th page/2” to the cumulative normal distribution.

Subsequently, in step S506, the image arranging section 36 completes the reading of the M-th page and ends the calculation of the cumulative normal distribution.

Returning to step S504, when the M-th page is not the left or the right of the center spread, the image arranging section 36 determines “No” and proceeds to step S507. In step S507, the image arranging section 36 adds “normal distribution of the M-th page” to the cumulative normal distribution.

Subsequently, in step S506, the image arranging section 36 returns to step S502, repeats the operation in step S502 to 5506 by the number of pages, completes the reading of the M-th page, and ends the calculation of the cumulative normal distribution.

By performing the calculation of the cumulative normal distribution explained above, it is possible to calculate arrangement in which the center spread is present in the dynamic portion V as shown in FIG. 14.

Referring back to FIG. 6 again, in step S208, the image arranging section 36 arranges the thumbnail images T of the pages and creates the thumbnail image bundle SG.

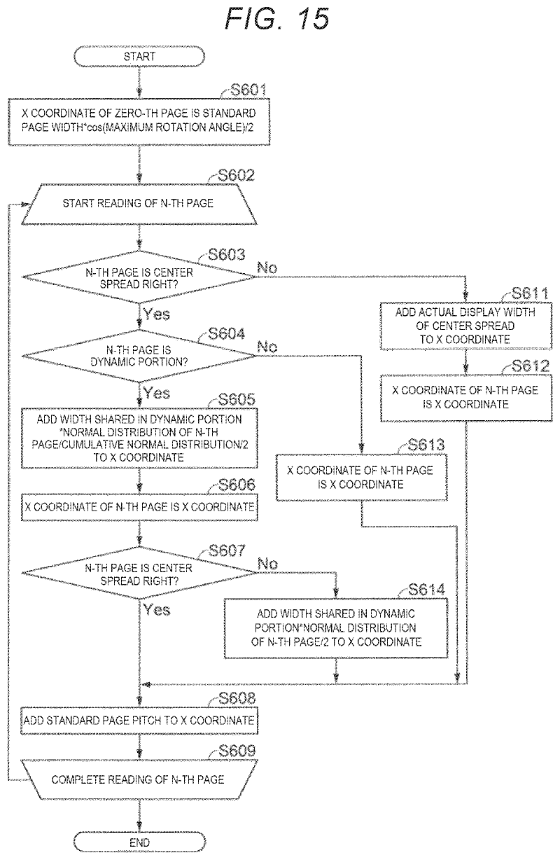

Operation for arranging pages by the image arranging section 36 is explained below according to the flowchart of FIG. 15.

First, in step S601, the image arranging section 36 sets an X coordinate of a zero-th page to “standard page width La*cos(maximum rotation angle θ max)/2”. The X coordinate is, when an end portion on the left side of both end portions opposed in the horizontal direction of a first page is set to 0, length in the X-axis direction, which is the horizontal direction, from the end portion on the left side.

Subsequently, in step S602, the image arranging section 36 starts reading of an N-th page of the original image P. N is an integer equal to or larger than 1.

Subsequently, when the N-th page is the right of the center spread in step S603, the image arranging section 36 determines “Yes” and proceeds to step S604. When the N-th page is the dynamic portion V in step S604, the image arranging section 36 determines “Yes” and proceeds to step S605.

Subsequently, in step S605, the image arranging section 36 adds “width shared in the dynamic portion*normal distribution of the N-th page/cumulative normal distribution/2” to the X coordinate.

Subsequently, in step S606, the image arranging section 36 sets an X coordinate of the N-th page as the X coordinate.

Subsequently, when the N-th page is the center spread right in step S607, the image arranging section 36 determines “Yes” and proceeds to step S608. When the N-th page is not the center spread right, the image arranging section 36 determines “No” and proceeds to step S614. In step S614, the image arranging section 36 adds “width shared in the dynamic portion*normal distribution of the N-th page/2” to the X coordinate and proceeds to step S608.

Subsequently, returning to step S604, when the N-th page is not the dynamic portion V, the image arranging section 36 determines “No”. In step S613, the image arranging section 36 sets an X coordinate of the N-th page as the X coordinate and proceeds to step S608.

Subsequently, returning to step S603, when the N-th page is not the center spread right, the image arranging section 36 determines “No” and proceeds to step S611. In step S611, the image arranging section 36 adds the actual display width of the center spread to the X coordinate.

Subsequently, in step S612, the image arranging section 36 sets an X coordinate of the N-th page as the X coordinate and proceeds to step S608.

Subsequently, in step S608, the image arranging section 36 adds the standard page pitch La to the X axis. In step S609, the image arranging section 36 returns to step S602, repeats the operation in steps S602 to S609 by the number of pages, completes the reading of the N-th page, and ends the calculation of X coordinates of the pages.

Thereafter, the thumbnail images T corresponding to the pages generated by the GUI base section 30 are arranged on the first imaginary rotation axis Q based on the X coordinates of the pages calculated by the image arranging section 36, whereby the generation of the thumbnail image bundle SG is ended.

Referring back to FIG. 5, in step S105, the control section 3 displays, on the image display section 2, the thumbnail image bundle SG formed by the thumbnail image T generated in step S104.

That is, the control section 3 displays, based on the thumbnail image T generated in step S104 including the display method according to the present disclosure, in other words, the display size of the standard image and the nonstandard image specified by the size with the reduced enlargement-reduction magnification, the thumbnail image bundle SG formed by the images including the standard image and the nonstandard image on the image display section 2 (a display step).

Since the display size of the nonstandard image is the size with the reduced enlargement/reduction magnification, it is possible to suppress or prevent a situation in which a size relation between the standard image and the nonstandard image is conspicuous in the generated thumbnail image bundle SG or it is difficult to visually recognize description content of the nonstandard image having the small display size or, when the small nonstandard image is arranged in the static portion L, it is difficult to visually recognize even the presence of the nonstandard image.

In the display of the thumbnail image bundle SG in the image display section 2, it is preferable to display the thumbnail image bundle SG through a first step of determining, based on the thumbnail image T forming the thumbnail image bundle SG, that is, the display sizes specified about the standard image and the nonstandard image, arrangement positions where the images including the standard image and the nonstandard image are arranged and a second step of drawing, in the determined arrangement positions, information included in the images corresponding to the arrangement positions to display the images on the image display section 2. By displaying the thumbnail image bundle SG through such steps, it is possible to display the thumbnail image T forming the thumbnail image bundle SG on the image display section 2 at more excellent position accuracy.

According to the flow explained above, the thumbnail image bundle SG arranged in the ascending order of page numbers from the right side to the left side is displayed on the image display section 2 along the horizontal direction of the image display section 2.

Various calculation values calculated in the steps are stored in the RAM 5 for each of the pages and, every time the calculation values are necessary for calculation, the calculation values are read out from the RAM 5 and used for various calculations.

With the viewer 10 functioning as the display device and the display method explained above, since the thumbnail image T arranged in the static portion L is displayed to partially overlap the thumbnail image T adjacent to the thumbnail image T, a part of description content of the thumbnail image T can be confirmed. Since the thumbnail image T arranged in the dynamic portion V is displayed such that the rotation angle θ centering on the second imaginary rotation axis M is smaller as the thumbnail image T is closer to the predetermined position K, the thumbnail image T closer to the predetermined position K has wider image width. Description content of the thumbnail image T is more easily confirmed. Therefore, it is possible to collectively confirm description contents of all the thumbnail images T.

Since the predetermined position K is present in the center in the dynamic portion V in the horizontal direction in which the plurality of thumbnail images T are arranged, the thumbnail images T having large image width are arranged on both sides of the predetermined position K. The description content of the thumbnail image T arranged in the dynamic portion V is more easily confirmed.

A display method of displaying images when the user performs predetermined operation using the buttons 7A to 7F or the touch panel 7G of the input section 7 and display methods programmed by programs other than the program for controlling the control section 3 are explained as a display example 1 to a display example 9.

### DISPLAY EXAMPLE 1

A display method of enlarging and displaying an image bundle is explained with reference to FIG. 16.

FIG. 16 is a diagram in which a thumbnail image bundle is enlarged and displayed. Components in the viewer 10 are explained while being denoted by the same reference numerals and signs as the reference numerals and signs described above.

As shown in FIG. 16, when the user moves the thumbnail image bundle SG with a finger as indicated by an arrow A1 and lifts the finger from the touch panel 7G, the control section 3 performs processing for enlarging the thumbnail image bundle SG at a predetermined enlargement ratio and displaying the enlarged thumbnail image bundle SG near a place to which the thumbnail image bundle SG is moved by the finger on the image display section 2. When the user moves the enlarged thumbnail image bundle SG downward with the finger and lifts the finger from the touch panel 7G, the enlarged thumbnail image bundle SG is changed to the thumbnail image bundle SG having the original size and displayed.

The enlarged thumbnail image bundle SG has the same length in the horizontal direction, which is the width direction, as the length of the original thumbnail image bundle SG. The thumbnail images T are enlarged at the predetermined enlargement ratio and displayed.

With this display method, by enlarging and displaying the thumbnail image bundle SG at the predetermined enlargement ratio, it is possible to easily recognize description contents of the thumbnail images T of the thumbnail image bundle SG.

### DISPLAY EXAMPLE 2

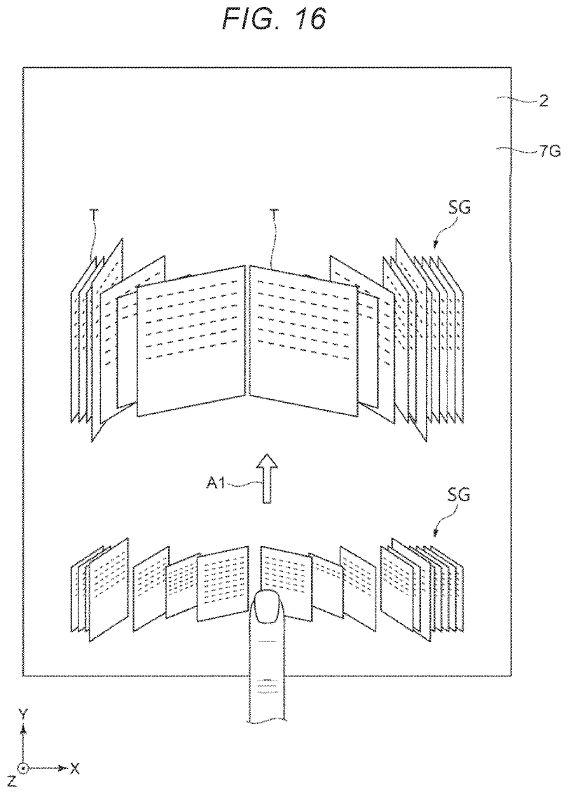

A display method of displaying an image bundle in which the number of images in the dynamic portion V is smaller than a predetermined number of images is explained with reference to FIG. 17.

FIG. 17 is a diagram of display of a thumbnail image bundle in which the number of images in the dynamic portion is smaller than the predetermined number of images. Components in the viewer 10 are explained while being denoted by the same reference numerals and signs as the reference numerals and signs described above.

As shown in FIG. 17, when the number of images in the dynamic portion V is smaller than the predetermined number of images, for example, when the predetermined number of images in the dynamic portion V is six and the number of images in the dynamic portion V is four, the control section 3 calculates arrangement in which imaginary two images are added to the left side of existing four images and displays, as shown in FIG. 17, four thumbnail images T on the right side in the dynamic portion V.

With this display method, since a small number of images are not discontinuously arranged and continuous images are displayed in a concentrated position. Therefore, the images appear beautiful.

### DISPLAY EXAMPLE 3

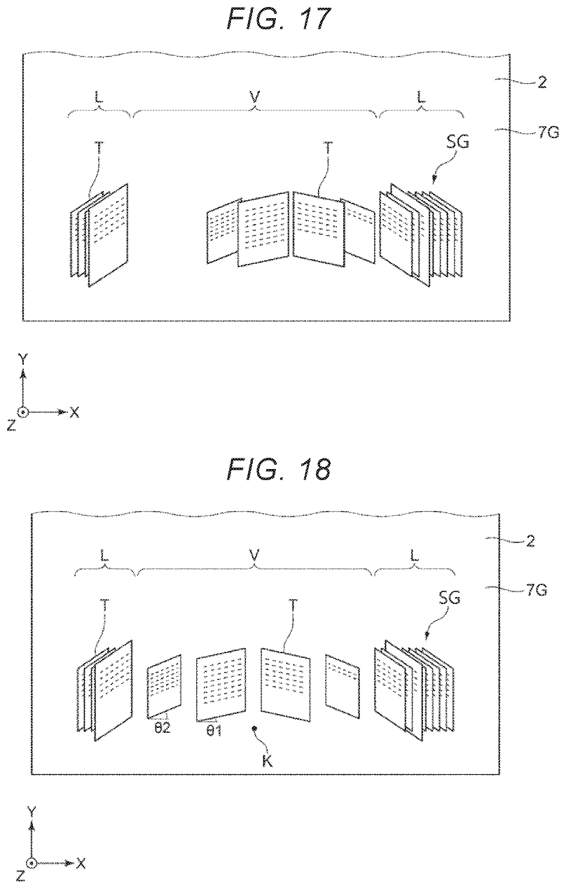

Another display method of displaying an image bundle in which the number of images in the dynamic portion V is smaller than a predetermined number of images is explained with reference to FIG. 18.

FIG. 18 is a diagram of display of a thumbnail image bundle in which the number of images in the dynamic portion is smaller than the predetermined number of images. Components in the viewer 10 are explained while being denoted by the same reference numerals and signs as the reference numerals and signs described above.

When the number of images in the dynamic portion V is smaller than the predetermined number of images as shown in FIG. 18, the user touches the thumbnail image T in the dynamic portion V with a finger, whereby the control section 3 performs processing for reducing the rotation angle θ of the thumbnail image T arranged in the dynamic portion V compared with when the predetermined number of images are arranged in the dynamic portion V and displaying the thumbnail image T. Specifically, when the number of images in the dynamic portion V is smaller than the predetermined number of images, the control section 3 sets the rotation angle θ1 of the thumbnail image T closest to the predetermined position K smaller than the rotation angle θ1 of the thumbnail image T closest to the predetermined position K at the time when the predetermined number of images are arranged in the dynamic portion V. The control section 3 sets the rotation angle θ2 of the thumbnail image T second closest to the predetermined position K smaller than the rotation angle θ2 of the thumbnail image T second closest to the predetermined position K at the time when the predetermined number of images are arranged in the dynamic portion V.

The display method may be a program for automatically controlling to reduce the rotation angle θ of the thumbnail image T arranged in the dynamic portion V when the number of images in the dynamic portion V is smaller than the predetermined number of images compared with when the predetermined number of images are arranged in the dynamic portion V.

With this method, by reducing the rotation angle θ centering on the second imaginary rotation axis M of the thumbnail image T in the dynamic portion V and displaying the thumbnail image T, the image width of the thumbnail image T arranged in the dynamic portion V further increases. It is easier to confirm the description content of the thumbnail image T arranged in the dynamic portion V.

### DISPLAY EXAMPLE 4

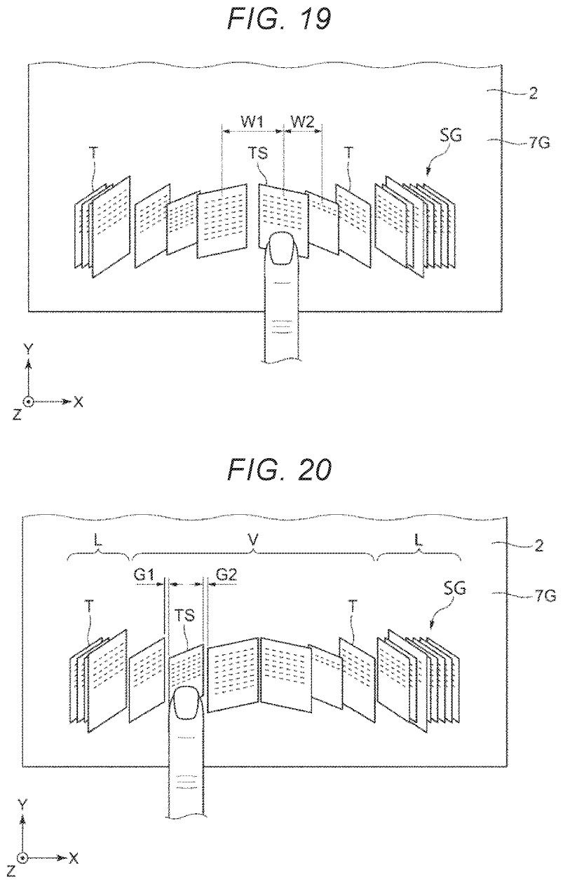

A display method of displaying an operation image and images adjacent to the operation image with intervals between the operation image and the images increased is explained with reference to FIG. 19.

FIG. 19 is a diagram in which an operation thumbnail image and thumbnail images adjacent to the operation thumbnail image are displayed with intervals between the operation thumbnail image and the thumbnail images increased. Components in the viewer 10 are explained while being denoted by the same reference numerals and signs as the reference numerals and signs described above.

When the user performs predetermined operation of, for example, touching an operation thumbnail image TS, which is an operation image, with a finger as shown in FIG. 19, the control section 3 performs processing for displaying the operation thumbnail image TS and the thumbnail images T adjacent to the operation thumbnail image TS with intervals between the operation thumbnail image TS and the thumbnail images T increased. Specifically, the operation thumbnail image TS and the thumbnail images T are displayed with an interval W1 between the operation thumbnail image TS and the thumbnail image T on the left side and an interval W2 between the operation thumbnail image TS and the thumbnail image T on the right side respectively increased from intervals before the predetermined operation of touching the operation thumbnail image TS with the finger.

With this display method, since the operation thumbnail image TS and the adjacent thumbnail images T are displayed with the intervals between the operation thumbnail image TS and the thumbnail images T increased, overlapping regions of the operation thumbnail image TS and the adjacent thumbnail images T decrease. It is easy to confirm description contents of the operation thumbnail image TS and the adjacent thumbnail images T.

### DISPLAY EXAMPLE 5

A display method of displaying an operation image and images adjacent to the operation image not to overlap is explained with reference to FIG. 20.

FIG. 20 is a diagram in which the operation thumbnail image and the thumbnail images adjacent to the operation thumbnail image are displayed not to overlap. Components in the viewer 10 are explained while being denoted by the same reference numerals and signs as the reference numerals and signs described above.

When the user performs predetermined operation of, for example, touching the operation thumbnail image TS, which is the operation image, arranged in the dynamic portion V with a finger for a predetermined time or more, for example, one second or more as shown in FIG. 20, the control section 3 performs processing for displaying the operation thumbnail image TS and the thumbnail images T adjacent to the operation thumbnail image TS not to overlap. Specifically, the operation thumbnail image TS and the thumbnail images T are displayed with an interval G1 provided between the operation thumbnail image TS and the thumbnail image T on the left side and an interval G2 provided between the operation thumbnail image TS and the thumbnail image T on the right side.

With this display method, since the operation thumbnail image TS and the adjacent thumbnail images T arranged in the dynamic portion V are displayed not to overlap, it is possible to easily confirm description contents of the operation thumbnail image TS and the adjacent thumbnail images T.

### DISPLAY EXAMPLE 6

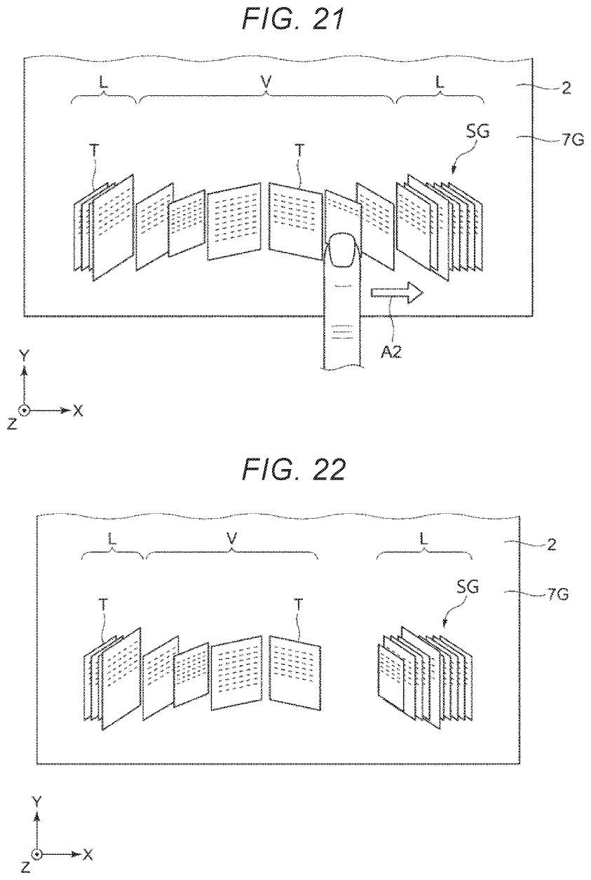

A display method of shifting an image in the dynamic portion V to the static portion L and displaying the image is explained with reference to FIGS. 21 and 22.

FIG. 21 is a diagram for explaining a method of shifting the thumbnail image in the dynamic portion to the static portion and displaying the thumbnail image. FIG. 22 is a diagram in which the thumbnail image in the dynamic portion is shifted to the static portion and displayed. Components in the viewer 10 are explained while being denoted by the same reference numerals and signs as the reference numerals and signs described above.

When the user touches the thumbnail image T arranged in the dynamic portion V with a finger and moves the thumbnail image T to the right side as indicated by an arrow A2 as shown in FIG. 21, the control section 3 performs processing for moving the thumbnail image T touched by the finger and the thumbnail image T arranged between the thumbnail image T touched by the finger and the static portion L to the static portion L and arranging and displaying the thumbnail images T in the static portion L as shown in FIG. 22. That is, the thumbnail image T displayed in the dynamic portion V can be moved to the static portion L. The thumbnail image T displayed in the static portion L can also be moved to the dynamic portion V. Specifically, the thumbnail image T in the static portion L can be displayed by touching the thumbnail image T with a finger and moving the thumbnail image T to the dynamic portion V.

With the display method, it is possible to reduce the thumbnail images T arranged in the dynamic portion V. The thumbnail images T arranged in the dynamic portion V are more easily seen.

### DISPLAY EXAMPLE 7

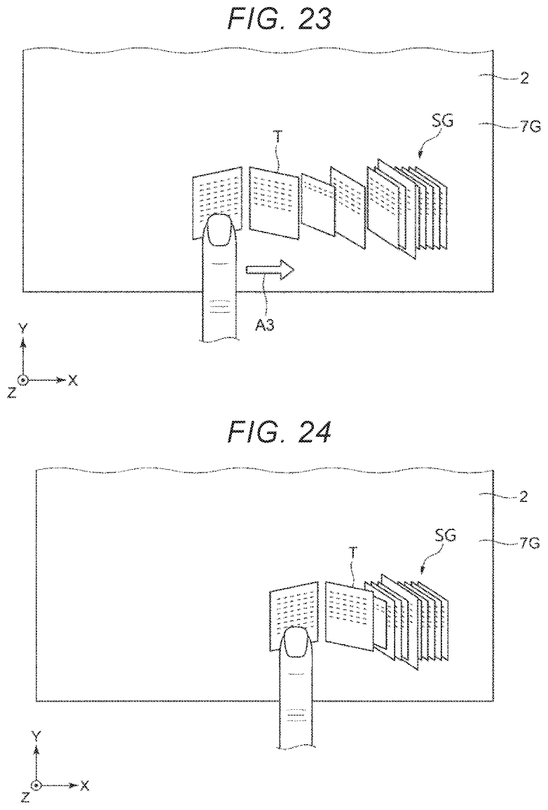

A display method of displaying an image bundle with the width of the image bundle reduced is explained with reference to FIGS. 23 and 24.

FIGS. 23 and 24 are diagrams for explaining a method of reducing the width of the thumbnail image bundle and displaying the thumbnail image bundle. Components in the viewer 10 are explained while being denoted by the same reference numerals and signs as the reference numerals and signs described above.

When the user touches the thumbnail image T arranged on the leftmost side of the thumbnail image bundle SG with a finger and moves the thumbnail image T to the right side as indicated by an arrow A3 as shown in FIG. 23, the control section 3 performs processing for reducing the length in the horizontal direction, which is the width direction, of the thumbnail image bundle SG and displaying the thumbnail image bundle SG as shown in FIG. 24. When the user lifts the finger from the touch panel 7G, the thumbnail image bundle SG having the original width is displayed. It is also possible to move the thumbnail image bundle SG to the left side and display the thumbnail image bundle SG with the length of the thumbnail image bundle SG reduced.

With this display method, when the thumbnail image bundle SG is displayed over the enlarged thumbnail image T, another thumbnail image bundle SG, or the like, by displaying the thumbnail image bundle SG with the width reduced, it is possible to easily confirm description content of the enlarged thumbnail image T or the thumbnail image bundle SG overlapping the thumbnail image bundle SG.

Contents derived from the embodiment explained above are described below.

In the display method, the enlargement/reduction magnification of the display size of the nonstandard image is reduced. Therefore, in the generated thumbnail image bundle SG, it is possible to suppress or prevent a situation in which the size relation between the standard image and the nonstandard image is conspicuous, it is difficult to visually recognize the description content of the nonstandard image having the small display size, or, further, when the small nonstandard image is arranged in the static portion L, it is difficult to visually recognize even the presence of the nonstandard image.

A display method is a display method of rotating each of a plurality of images arranged on a first imaginary axis around respective second imaginary axes crossing the first imaginary axis, further rotating the image around the first imaginary axis, and causing a display section to display the image. An image bundle formed by the plurality of images arranged along a first direction includes a static portion L in which the images are arranged at an equal interval in a state in which the image bundle is displayed to partially overlap the images adjacent to the image bundle and a dynamic portion V in which the images are arranged with an interval between the images adjacent to each other set larger than an interval between the images in the static portion L. The image displayed in the dynamic portion V is movable to the static portion L. The image in the dynamic portion V has a smaller rotation angle centering on the second imaginary axis along a second direction crossing the first direction as the image is closer to a predetermined position.

With this display method, since the image arranged in the static portion L is displayed to partially overlap the image adjacent to the image, a part of description content of the image can be confirmed. Since the image arranged in the dynamic portion V is displayed such that the rotation angle centering on the second imaginary axis is smaller as the image is closer to the predetermined position, an image width is larger in the image closer to the predetermined position. It is easier to confirm description content of the image. Therefore, it is possible to collectively confirm description contents of all the images.

In the display method, the predetermined position may be a center of the dynamic portion V in the first direction.

With this display method, since the predetermined position is the center of the dynamic portion V in the first direction in which the plurality of images are arranged, images having a large image width are arranged on both sides of the predetermined position. It is easier to confirm the description content of the image arranged in the dynamic portion V.

In the display method, when the image bundle is moved in the second direction, the image bundle may be enlarged at a predetermined enlargement ratio and displayed.

With this display method, by enlarging the image bundle at the predetermined enlargement ratio and displaying the image bundle, it is possible to easily recognize description contents of the images of the image bundle.

In the display method, when the plurality of images in the dynamic portion V is fewer than a predetermined number of images, the plurality of images in the dynamic portion V may be displayed with the rotation angle of the plurality of images set smaller than the rotation angle in the case of the predetermined number of images.

With this display method, by displaying the image in the dynamic portion V with the rotation angle centering on the second imaginary axis set smaller, the image width of the image arranged in the dynamic portion V further increases. It is easier to confirm the description content of the image arranged in the dynamic portion V.

In the display method, when the images, the length of which in the first direction is long compared with the length in the second direction, are more than the images, the length of which in the first direction is short compared with the length in the second direction, in the dynamic portion V, the images may be displayed with the number of images in the dynamic portion V reduced than when the images, the length in the first direction of which is short compared with the length in the second direction, are more.

With this display method, when longitudinally long images, the length of which in the first direction is long compared with the length in the second direction, are more than laterally long images, the length of which in the first direction is short compared with the length in the second direction, by displaying the images with the number of images in the dynamic portion V reduced, an interval between the laterally long image and an image adjacent to the laterally long image increases and an overlapping region decreases. Therefore, it is easier to confirm description content of the laterally long image arranged in the dynamic portion V.

In the display method, when a part of the image bundle is not displayed, the image bundle may be displayed with, of both end portions opposed in the second direction of each of the plurality of images forming the image bundle, at least one end portion aligned.

With this display method, even when a longitudinally long image and a laterally long image are mixed in the plurality of images forming the image bundle and one of both end portions opposed in the second direction of the plurality of images is not displayed, it is possible to confirm description content of the laterally long image by displaying the plurality of images forming the image bundle with, of the both end portions opposed in the second direction of the plurality of images, one end portion aligned.

In the display method, an operation image for which predetermined operation is performed in the image bundle may be displayed with an interval between the operation image and the image adjacent to the operation image increased than before the predetermined operation.

With this display method, since the operation image and the adjacent image are displayed with the interval between the operation image and the adjacent image increased, an overlapping region of the operation image and the adjacent image decreases. It is easy to confirm description contents of the operation image and the adjacent image.

In the display method, when an operation image for which predetermined operation is performed in the image bundle is arranged in the dynamic portion V, the images adjacent to each other may be displayed not to overlap.

With this display method, since the operation image and the images adjacent to each other arranged in the dynamic portion V are displayed not to overlap, it is possible to easily confirm description contents of the operation image and the images adjacent to each other.

In the above explanation of the display method, in the thumbnail image bundle, a part of the thumbnail images overlaps an image located behind the image. However, in the thumbnail image bundle, the thumbnail images may be arranged not to overlap one another.

Further, in the thumbnail image bundle, the thumbnail images may be arranged without inclining.

However, as explained above, in the thumbnail image bundle, when apart of the thumbnail images overlaps the image located behind the image and the thumbnail images are arranged to incline, by applying the present disclosure, it is possible to more markedly exert the effects obtained by the present disclosure.

A display device includes: a display section configured to display an image bundle formed by a plurality of images arranged along the first direction; an image generating section configured to rotate each of the plurality of images arranged on a first imaginary axis along the first direction around respective second imaginary axes crossing the first imaginary axis, further rotate the image around the first imaginary axis, and create the plurality of images; causing a display section to display the image; and a control section configured to cause the display section to display the image bundle including a static portion L in which the images are arranged at an equal interval in a state in which the image bundle is displayed to partially overlap the images adjacent to the image bundle and a dynamic portion V in which the images are arranged with an interval between the images adjacent to each other set larger than an interval between the images in the static portion L and cause the display section to display the images in the dynamic portion V to have a smaller rotation angle centering on the second imaginary axis along a second direction crossing the first direction as the image is closer to a predetermined position.

With this display device, since the image arranged in the static portion L is displayed to partially overlap the image adjacent to the image, a part of description content of the image can be confirmed. Since the image arranged in the dynamic portion V is displayed such that the rotation angle centering on the second imaginary axis is smaller as the image is closer to the predetermined position, an image width is larger in the image closer to the predetermined position. It is easier to confirm description content of the image. Therefore, it is possible to collectively confirm description contents of all the images.

The display device according to the present disclosure can be applied to, besides the viewer shown in FIG. 1, for example, a personal computer, a cellular phone, a digital still camera, a television, a video camera, a video tape recorder, a car navigation device, an electronic dictionary, an electronic calculator, an electronic game machine, a word processor, a work station, a videophone, a television monitor for crime prevention, electronic binoculars, a POS terminal, an electronic device including a touch panel, medical equipment, a fish finder, various measurement instruments, meters, a flight simulator, other various monitors, and a display device including an image display section such as a projection-type display device such as a projector.

The display method and the display device according to the present disclosure are explained above based on the embodiment shown in the figures. However, the present disclosure is not limited to the display method and the display device.

For example, in the display method according to the present disclosure, one or more steps for any purposes may be added according to necessity.

In the display device according to the present disclosure, the components can be substituted with any components that can exert the same functions or components having any configurations can be added.

What is claimed is:

1. A display method comprising:
a specifying step of, in an image group including a standard image having size of a standard size and a nonstandard image having size different from the standard size, reducing, for the nonstandard image, an enlargement/reduction magnification with respect to the standard size and specifying display sizes of the standard image and the nonstandard image; and
a display step of displaying, based on the specified display sizes, images including the standard image and the nonstandard image.

2. The display method according to claim 1, wherein, among a plurality of images sampled from the image group, an image having size of a same size as size of a largest number of images is set as the standard image.

3. The display method according to claim 1, wherein, in the specifying step, size of the images is determined based on sizes of diagonal lines of the images.

4. The display method according to claim 3, wherein, when the enlargement/reduction magnification of the nonstandard image is represented as y, the enlargement/reduction magnification y is calculated by
y=a(arctan(b(x−1))+π/2)
where, size of a diagonal line of the standard image is set to 1, the enlargement/reduction magnification of the standard image is set to 1, size of a diagonal line of the nonstandard image is represented as c=(x+1) (0<c≤6), a limit value of an enlargement magnification is represented as aπ, and an inclination angle of the enlargement-reduction magnification is represented as b.

5. The display method according to claim 1, wherein, in the image group, a part of the images overlaps an image located behind the images.

6. The display method according to claim 1, wherein, in the display step, the images are displayed to incline.

7. The display method according to claim 1, wherein the display step includes a first step of determining, based on the display sizes specified in the specifying step, arrangement positions where the images are arranged and a second step of displaying the images in the arrangement positions.

8. A display device comprising:
an image display section configured to display an image;
an image-size acquiring section configured to acquire, in an image group including a standard image having size of a standard size and a nonstandard image having size different from the standard size, the size of the standard image and the size of the nonstandard image;
an image arranging section configured to reduce, for the nonstandard image, an enlargement/reduction magnification with respect to the standard size and specify display sizes of the standard image and the nonstandard image; and
an image processing section configured to cause, based on the specified display sizes, the image display section to display images including the standard image and the nonstandard image.
